(19) United States
(12) Patent Application Publication
(10) Pub. No.: US 2015/0175079 A1
(43) Pub. Date: Jun. 25, 2015

(54) COMBINATION STEP RAIL ASSEMBLY FOR USE AS A STEP PLATFORM OR A RAMP ON A VEHICLE

(71) Applicant: JAC PRODUCTS, INC., Saline, MI (US)

(72) Inventors: Gerard J. KMITA, Allen Park, MI (US); Jeffrey M. AFTANAS, Ortonville, MI (US)

(21) Appl. No.: 14/568,992

(22) Filed: Dec. 12, 2014

Related U.S. Application Data
(60) Provisional application No. 61/919,314, filed on Dec. 20, 2013.

(51) Int. Cl. B60R 3/00; B65G 69/30

(52) U.S. Cl. CPC B60R 3/007; B65G 69/30

(57) ABSTRACT

The present disclosure relates to a step rail system readily configurable for use as either a step platform along a side of a motor vehicle, or also as a loading ramp for use in loading cargo into a cargo bed of the motor vehicle. The step rail system has a step assembly forming a tubular assembly, and a plurality of support elements each having a first end and a second end. The first end is affixed to a portion of the vehicle, and the second end supports the step assembly thereon. A striker is fixedly secured to one of the support elements. A user engageable latching assembly is carried on the step assembly for releasably engaging the striker when the step assembly is positioned on the support elements, to thus secure the step assembly to the support elements in a first configuration for use as the step platform, and enabling the step assembly to be detached from the support elements and used as a loading ramp.

### CROSS-REFERENCE TO RELATED APPLICATIONS

The present application claims priority from U.S. provisional patent application Ser. No. 61/919,314, filed on Dec. 20, 2013, the disclosure of which is hereby incorporated by reference into the present disclosure.

### FIELD

The present disclosure relates to ramps that are used to help load small vehicles into the bed of a pickup truck, and more particularly to a stowable ramp system that enables a pair of ramps to be stowed on the vehicle in a highly convenient manner, and used as step platforms on opposing sides of the vehicle.

### BACKGROUND

The statements in this section merely provide background information related to the present disclosure and may not constitute prior art.

The popularity of pickup trucks is presently rising, in part because of the high degree of utility that pickup trucks provide to individuals in transporting a wide variety of cargo. One particular type of cargo that individuals often transport in the bed of a pickup truck is all terrain vehicles (ATVs). Another is off road motorcycles (i.e., dirt bikes) as well as everyday motorcycles. Riding lawn mowers, bicycles and other wheeled vehicles often also transported in the bed of a pickup truck.

At the present time conventional lightweight ramps, typically made from aluminum, are usually used to help load such wheeled vehicles into an out from the bed of a pickup truck. While using ramps can be a satisfactory means for loading and unloading wheeled vehicles, storage of the ramps on the vehicle presents some significant drawbacks. Perhaps the biggest drawback is that storage of the ramps in the bed of the pickup truck takes up valuable space. As a result, there is less space in the bed available for use in the bed when the ramps are not needed and are being stowed. There is also no quick and convenient way to secure the ramps in the bed. Typically bungee cords or other like implements are used by an individual to secure the ramps in the bed. And if a bungee cord or other like implement is not available, then the user may be forced to simply let the ramps rest on the floor of the bed. This may result in shifting or bouncing of the ramps in the bed if the vehicle must be driven off road or on uneven road surfaces. Having the ramps bouncing and shifting around in the bed can be unsettling to the driver, as well as noisy. Movement of the ramps in the bed might potentially damage other cargo being carried in the bed.

Still further, with no convenient place to store the ramps on a pickup truck, there is an increased chance that the user may not have the ramps with him/her if (or when) the need arises for their use. Accordingly, it would be highly desirable to have a system in which the ramps are stowed on the vehicle when not needed for use, but which does not take up valuable space in the bed of the pickup truck. It would also be highly desirable if the ramps could operate as step rails for the vehicle when placed in their stowed positions. Such a system would ideally not involve any extensive disassembly or removal procedures to remove the ramps from their stowed positions and place them in an operative position. Still further, such a system would allow the ramps to be stowed after use without complicated securing procedures and external tools being required. Still further, such a system would ideally add little or no appreciable weight to the pickup truck itself, detract from its aerodynamics or otherwise significantly complicate the construction/design of the bed or any other area of the vehicle.

### SUMMARY

In one aspect the present disclosure relates to a step rail system readily configurable for use as either a step platform along a side of a motor vehicle, or also as a loading ramp for use in loading cargo into a cargo bed of the motor vehicle. The step rail system may include a step assembly forming a tubular assembly, and a plurality of support elements each having a first end and a second end. The first end is affixed to a portion of the vehicle, and the second end supports the step assembly thereon. A striker is fixedly secured to one of the support elements. A user engageable latching assembly is carried on the step assembly for releasably engaging the striker when the step assembly is positioned on the support elements, to thus secure the step assembly to the support elements in a first configuration for use as the step platform. The user engageable latching assembly enables the step assembly to be detached from the support elements and used as a loading ramp to facilitate movement of cargo to and from the cargo area of the vehicle.

In another aspect the present disclosure relates to a step rail system readily configurable for use as either a step platform along a side of a motor vehicle, or also as a loading ramp for use in loading cargo into a cargo bed of the motor vehicle. The step rail system may include a step assembly forming a tubular assembly having a rectangular element. A plurality of support elements may be included which each having a first end which is affixed to a portion of the vehicle, and a second end on which the step assembly may be supported. A striker may be fixedly secured to each one of a pair of the support elements. A user engageable latching assembly may be carried on the step assembly for releasably engaging the striker when the step assembly is positioned on the support elements, to thus secure the step assembly to the support elements in a first configuration for use as the step platform. The latching assembly may include a pivotally moveable latch body having a lock enabling the step assembly to be locked to the support elements. The user engageable latching assembly enables the step assembly to be detached from the support elements and used as a loading ramp to facilitate movement of cargo to and from the cargo area of the vehicle.

In still another aspect the present disclosure relates to a step rail system readily configurable for use as either a step platform along a side of a motor vehicle, or also as a loading ramp for use in loading cargo into a cargo bed of the motor vehicle. The step rail system may include a step assembly forming a tubular assembly having a rectangular element. A plurality of support elements may be included which each have a first end which is affixed to a portion of the vehicle, and a second end on which the step assembly may be supported. A striker may be fixedly secured to each one of a pair of the support elements. A user engageable latching assembly may be carried on the step assembly for releasably engaging the striker when the step assembly is positioned on the support elements. This enables the step assembly to be secured to the support elements in a first configuration for use as the step platform. The latching assembly may include a pivotally moveable latch body having a lock enabling the step assembly to be locked to the support elements. A telescopically extendable grapple may be secured to one end of the step assembly to be telescopically extended and retracted from the rectangular element without being detachable therefrom. The grapple may be configured to engage an edge surface of the cargo bed when the step assembly is being used as a ramp. A manually engageable grapple release assembly may be included for enabling a user to release the grapple and move the grapple to an extended position from a retracted position using a finger of one hand, and for further enabling the grapple to be secured in a retracted position. The user engageable latching assembly further enables the step assembly to be detached from the support elements and used as a loading ramp to facilitate movement of cargo to and from the cargo area of the vehicle.

### BRIEF DESCRIPTION OF THE DRAWINGS

The drawings described herein are for illustration purposes only and are not intended to limit the scope of the present disclosure in any way.

FIG. 1 is a perspective view of a pickup truck incorporating a pair of stowable ramps in accordance with the present disclosure;

FIG. 2 is an enlarged perspective view of one of the ramps being supported within a pair of opposing support elements, wherein the support elements are fixedly secured to a frame portion of the pickup truck.

FIG. 3 is a perspective view one of the ramps being slid out from supports that themselves would be fixedly attached to a frame portion of the vehicle;

FIG. 4 is a plan view of one configuration of the ramps;

FIG. 5 is a rear view of the vehicle of FIG. 1 with the ramps in position being supported from the rear bumper of the vehicle;

FIG. 6 is a side view of the ramp system of FIG. 1 showing one end of one of the ramps engaged within a notch in an inside surface of the vehicle's tail gate while the tail gate is in the down (open) position;

FIG. 7 is a side view of another embodiment of the present disclosure in which the ramps have pivotally mounted end panels;

FIG. 8 is a perspective view of another embodiment of the present disclosure in which the ramps each have folding end panels that fold within cutout sections in a central portion of the ramp;

FIG. 9 is a perspective view of another embodiment of the present disclosure in which the entire ramp component is slid out from fixedly mounted rails;

FIG. 10 is an end view in accordance with line 10 in FIG. 9 showing a locking mechanism for locking one end of the ramp of FIG. 9 to its associated rail;

FIG. 11 is a perspective view of a step rail system in accordance with another embodiment of the present disclosure;

FIG. 12 is an exploded perspective view of the step assembly of FIG. 11;

FIG. 13 is a cross sectional end view taken in accordance with section line 13-13 in FIG. 11 showing the attachment of the ramp fitting to a rectangular element of the step assembly;

FIG. 14 is a perspective plan view of the grapple;

FIG. 15 is a perspective view of a lower surface of the grapple of FIG. 14;

FIG. 16 is a left side view of the grapple of FIG. 14;

FIG. 17 is a right side view of the grapple of FIG. 14;

FIG. 18 is an exploded perspective view of various components of the grapple release assembly;

FIG. 19 is a rear perspective view of the grapple release button;

FIG. 20A is a perspective view of a rear area of the housing of the grapple assembly;

FIG. 20B is a side view of the housing of FIG. 20A;

FIG. 21 is a side view of the rectangular member of the step assembly;

FIG. 22 is a cutaway perspective view of the grapple and the latching assembly showing the latching assembly latched to the striker associated with one of the support elements;

FIG. 23 is a perspective view of a lower surface of the step assembly showing the step assembly being supported by one of the support elements;

FIG. 24 is a cross sectional end view taken in accordance with section line 24-24 in FIG. 11 showing the latching assembly engaged with the striker, thus securing the step assembly to the support element;

FIG. 25 is a plan view of the latch plate with the striker engaged in the opening in the latch plate, showing how the head portion of the striker is larger than the opening in the latch plate and thus prevents the step assembly from simply being lifted off of the support element when the latching assembly is in its latched orientation; and

FIG. 26 is a cutaway perspective view showing one of the ring-like elements engaged within a key-like opening in a lower surface of the rectangular member of the step assembly, to thus help retain the step assembly to the support element.

### DETAILED DESCRIPTION

The following description is merely exemplary in nature and is not intended to limit the present disclosure, application, or uses. It should be understood that throughout the drawings, corresponding reference numerals indicate like or corresponding parts and features.

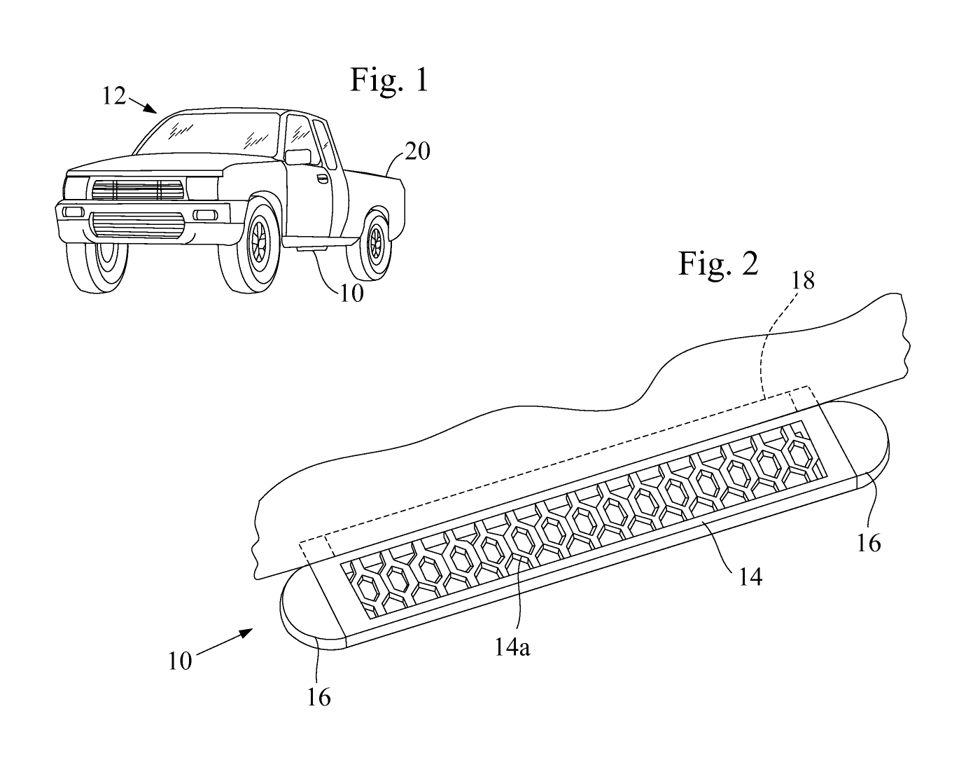

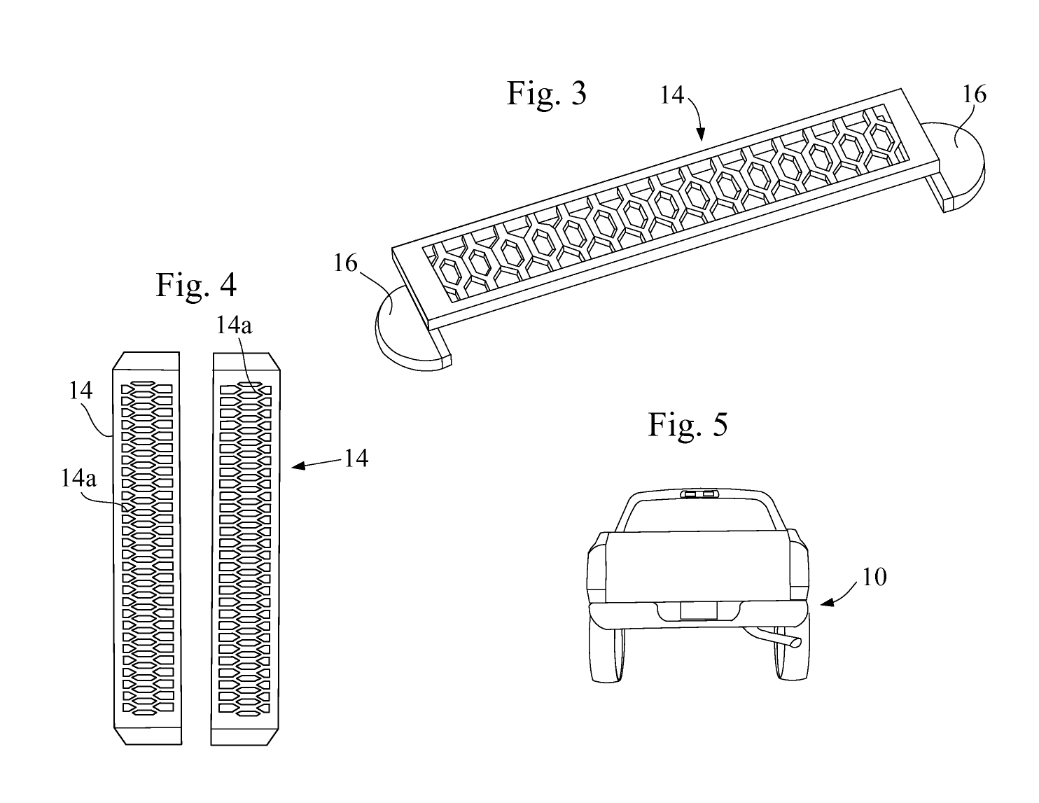

Referring to FIG. 1, there is shown a vehicle 12 including a stowable ramp system 10 in accordance with the present disclosure. It will be appreciated immediately that while the vehicle depicted is a pickup truck, the stowable ramp system 10 (hereinafter “system 10”) could just as easily be used on a sport utility vehicle (SUV) a minivan, a commercial van or any other type of motor vehicle that has a compartment within which cargo can be carried. Accordingly, while the following references use of the system 10 with a pickup truck, the system 10 may potentially be implemented with a wide variety of other types of vehicles.

Referring further to FIGS. 1 and 2, the system 10 incorporates a slidable ramp 14 that may be supported from a pair of support elements 16 when in its stowed position. The support elements 16 may be secured to a frame member 18 of the vehicle 12 or any other suitable strong and rigid structure. The ramp 14 forms a step when in its stowed position. As such, storage of the ramp 14 is accomplished in a highly effective and useful manner. The ramp effectively forms double duty as a step to help a driver or passenger gain entry to the cab of the vehicle 12 when the ramp 14 is stowed, and as a ramp to enable larger items, especially wheeled items such as ATVs, motorcycles, riding or push behind lawn mowers, etc., to be easily loaded in the bed 20 of the vehicle 12.

Referring further to FIGS. 2 and 4, the ramps 14 may each have beveled corners 14a to help aid their insertion into the support elements 16 when they are being stowed. The ramps 14 may also have a grated or otherwise textured area 14a which helps to provide traction for the user as the user is entering or exiting the cab of the vehicle 12, as well as to provide traction when cargo is being wheeled up the ramps 14. FIG. 5 shows the ramps 14 positioned from a tailgate 22 of the vehicle 12.

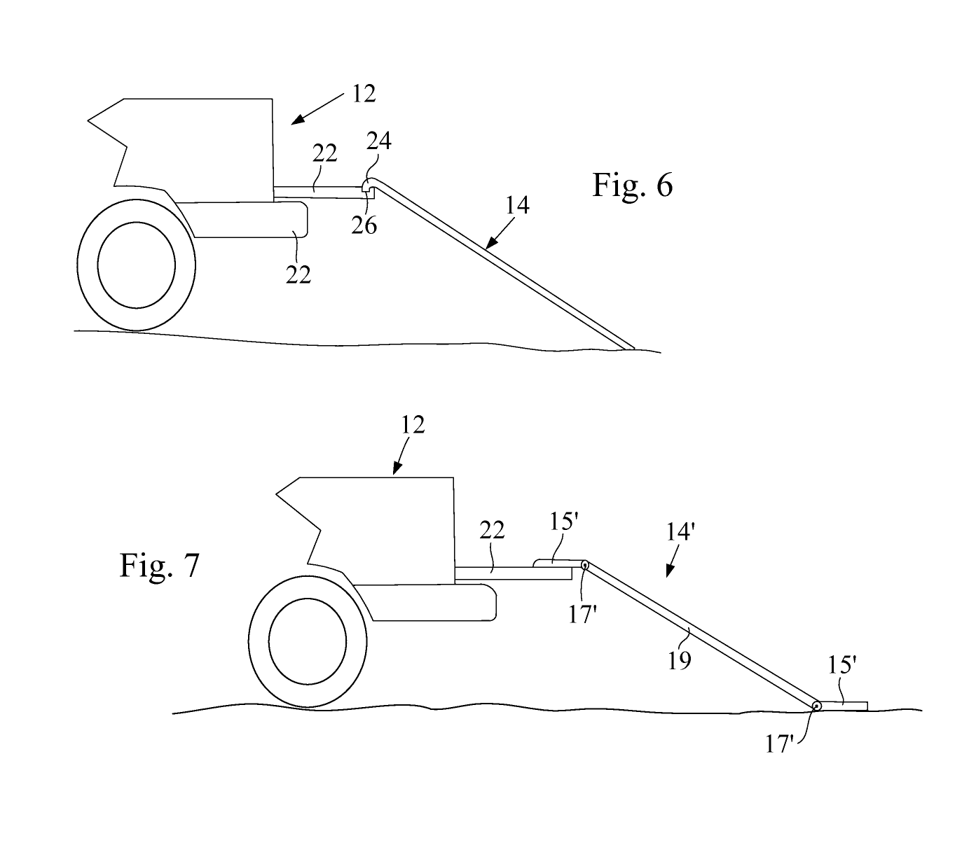

FIG. 6 illustrates a side view of one of the ramps 14 being supported at one end from the tailgate 22 of the vehicle 12. The ramps 14 may have suitable structure, for example a projecting tab 24 or like component, that rests within a recess or opening 26 near the edge of the tailgate 22. Thus, to install the ramps 14 for use the user would simply align the projecting tab 24 with the recess or opening 26 and then lower that end of the ramp 14 to engage the projecting tab 24 in the recess or opening 26. The precise lengths of the ramps 14 may be selected to optimize their use as steps for aiding ingress and egress from the vehicle as well as well their use as loading/unloading ramps. It will be appreciated that increasing the lengths of the ramps will enable a less steep approach angle to be formed when the ramps, which should aid loading and unloading cargo (e.g., ATVs, motorcycles, etc.) from the bed area, but at the same time increase the overall weight of the ramps.

FIG. 7 shows ramps 14′ in accordance with another configuration in which the ramps 14′ have end panels 15′ that are pivotally coupled via a pivot or hinge structure 17′ with a central portion 19′ of the ramp 14′. One of the end panels 15′ may rest flat on an inner surface of the tail gate 22 while the other rests flat on the ground surface. One of the end panels 15′ that is intended to be supported from the tailgate 22 may also include a projecting tab or similar structure (not shown), such as projecting tab 24, to positively connect it to the tailgate 22.

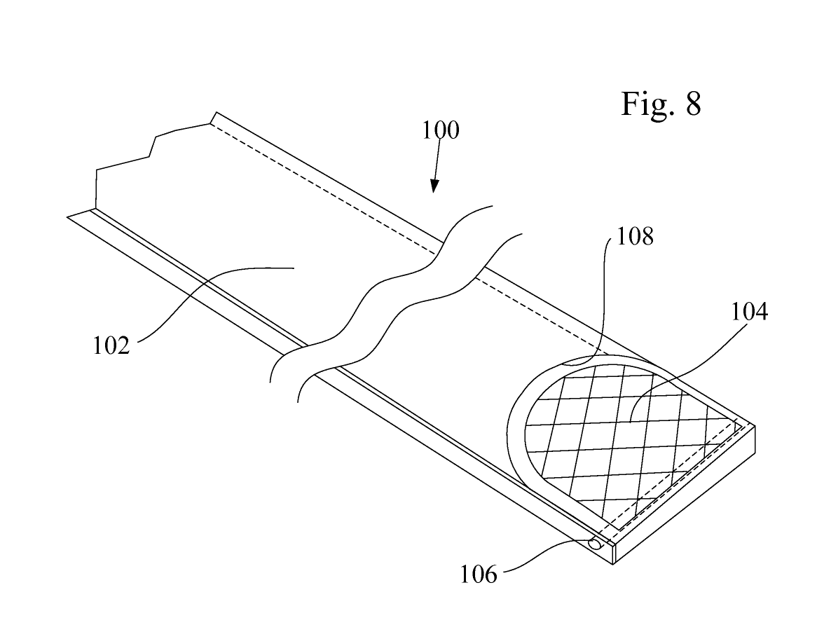

FIG. 8 shows a ramp 100 in accordance with another embodiment of the present disclosure. In this embodiment the ramp 100 has a central portion 102 and a folding end panel 104 at each end thereof. Each folding end panel is supported by a pivot bolt 106 which enables the end panels 104 to be folded within a complementary shaped cutout section 108 in the central portion 102. Alternatively, the folding end panels 104 could be slidably mounted in suitable rails such that they may be easily slid outwardly from the central portion 102 when required for use.

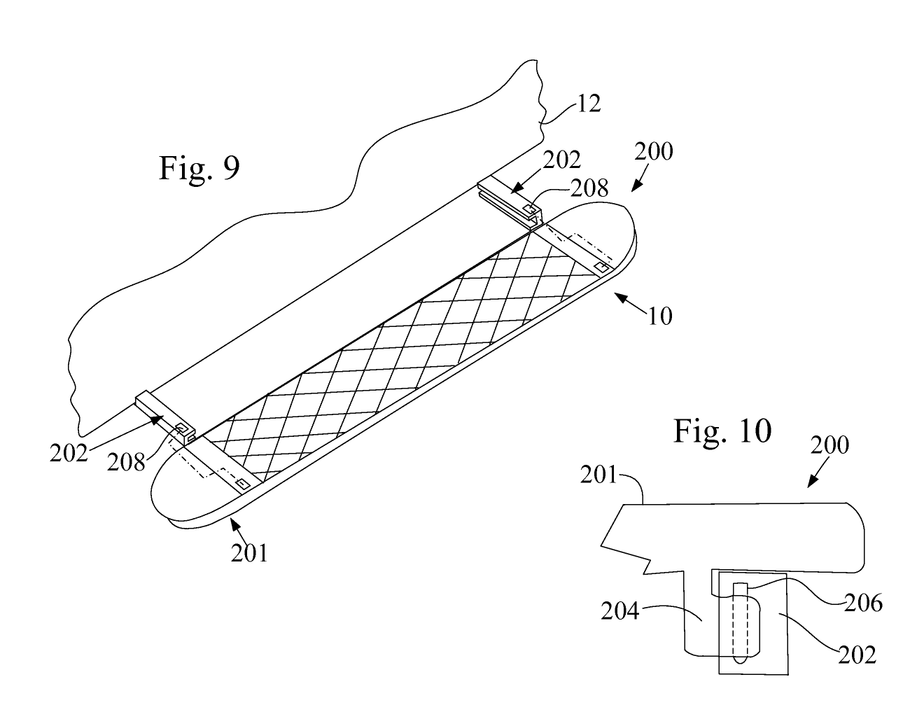

FIGS. 9 and 10 show a ramp system 200 in accordance with another embodiment of the present disclosure in which a ramp component 201 may be slid out from rails 202 mounted to a suitable frame portion of the vehicle 12. The ramp 201 may include suitable rail-engaging components 204 (FIG. 10) which slidably engage the rails 202. Each rail component 204 may include a suitable locking element 206, which may be a spring loaded tab or other like component which engages within a cutout 208 (FIG. 9) in its respective rail 202. In this manner as the user slides the ramp component 201 onto the rails 202, the locking elements 206 automatically latch in their respective cutouts 208. Releasing the ramp component 201 may involve the user manually pressing on a spring loaded release component 210 (FIG. 10) at each end of the ramp element 201, and then sliding the ramp component out from the rails 202.

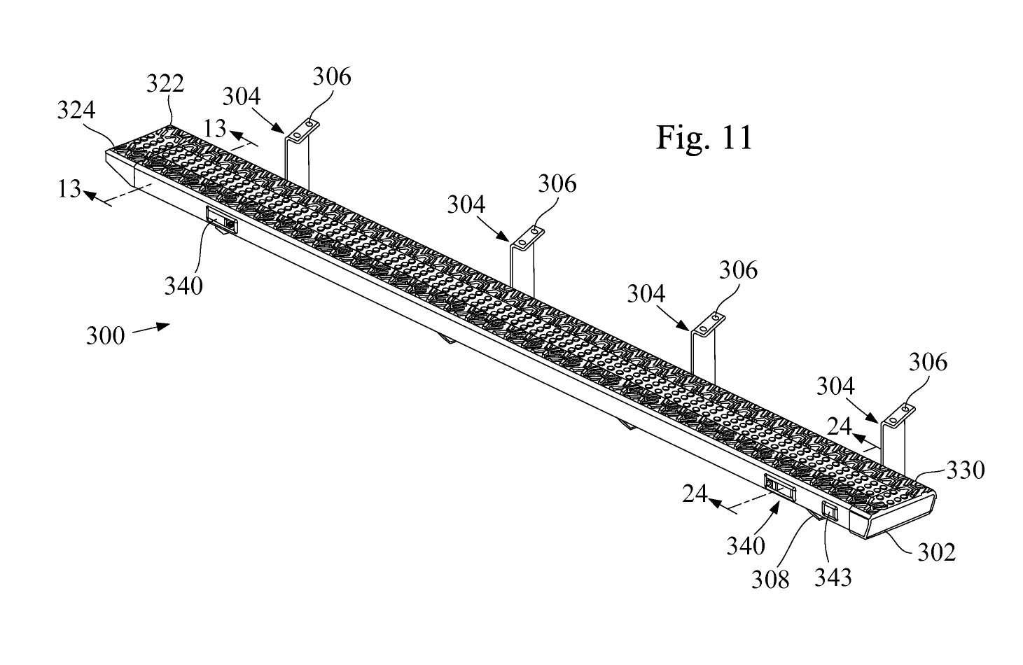

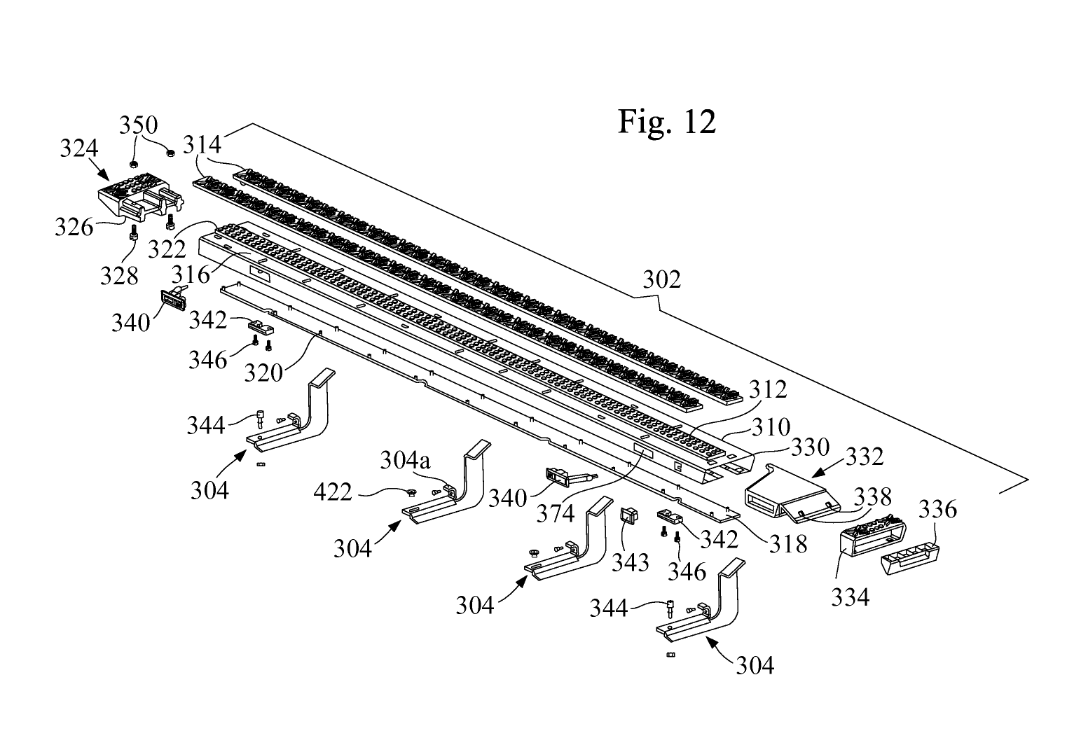

Referring to FIGS. 11 and 12, there is shown a step rail system 300 in accordance with another embodiment of the present disclosure. In FIG. 11 the system 300 is shown configured for use as a step rail to assist a user in stepping into and out from a motor vehicle, for example a pickup truck, SUV, van, etc. The system 300 in this example includes a step assembly 302 and a plurality of support elements 304. The support elements 304 have a first end 306 which may be fixedly attached such as by threaded bolts to a frame portion of a vehicle. A second end 308 of each support element 304 is used to support the step assembly 302 thereon. In one configuration the support elements 304 each have a generally L-shaped configuration, as best seen in FIG. 12, with a hook portion 304a. However, any suitable shape may be used provided it enables the support element 304 to be secured to the frame portion of the vehicle and to act as a support for the step assembly 302.

With reference to FIG. 12, the step assembly 302 includes an elongated, rectangular element 310 having a corrugated or stippled metal section 312 along a midpoint thereof. Rubber or elastomer pads 314 are secured to the rectangular element 310 using openings 316 formed on the rectangular element. A metal or plastic panel 318 may be used to close off the opening in the rectangular element 310 via conventional threaded fasteners 320.

A first end 322 of the rectangular element 310 may be closed off by a ramp fitting 324 configured with a neck portion 326 which fits snuggly into the rectangular element 310. The ramp fitting 324 may be secured to the rectangular element 310 using conventional threaded fasteners 328.

A second end 330 of the rectangular element 310 may have a telescopically extendable grapple 332 secured for sliding telescopic movement relative to the rectangular element 310. This enables the second end 330 of the step assembly 302 to be positioned on an edge of a cargo area when the step assembly 302 is being used as a ramp to load or unload cargo from the vehicle cargo area. A rubber, elastomer or like grapple cover 334 may be positioned over the grapple 332, and a grapple cap 336 secured to the grapple using holes 338 in the grapple and conventional threaded fasteners (the fasteners not being shown in FIG. 12), or by simply being snapped in place with suitable conventional fasteners.

The step assembly 302 also includes at least one, but preferably a pair, of latching assemblies 340. The latching assemblies 340 cooperate with latch plates 342 and strikers 344 to permit the step assembly 302 to be detachably secured to the support elements 304, and then released from the support elements by grasping the latching assemblies and rotating them outwardly into unlatched positions. The strikers 344 are secured to the rectangular element 310 by a plurality of conventional threaded fasteners 346. Grapple release button 343 forms a part of a grapple latching system 387 (FIG. 18) and allows the grapple 332 to be released and telescopically extended from the rectangular element 310 when the step assembly 302 is to be used as a ramp, as well as retained in a telescopically retracted position within the rectangular component 310 when the step assembly 302 is being used as a step platform.

When the latching assemblies 340 are each in their unlatched positions, the entire step assembly 302 may be removed from the support elements 304. When in their latched orientations, the latching assemblies 340 engage with the strikers 344 to prevent the step assembly 302 from being removed from the support elements 304. This important feature will be described further in the following paragraphs.

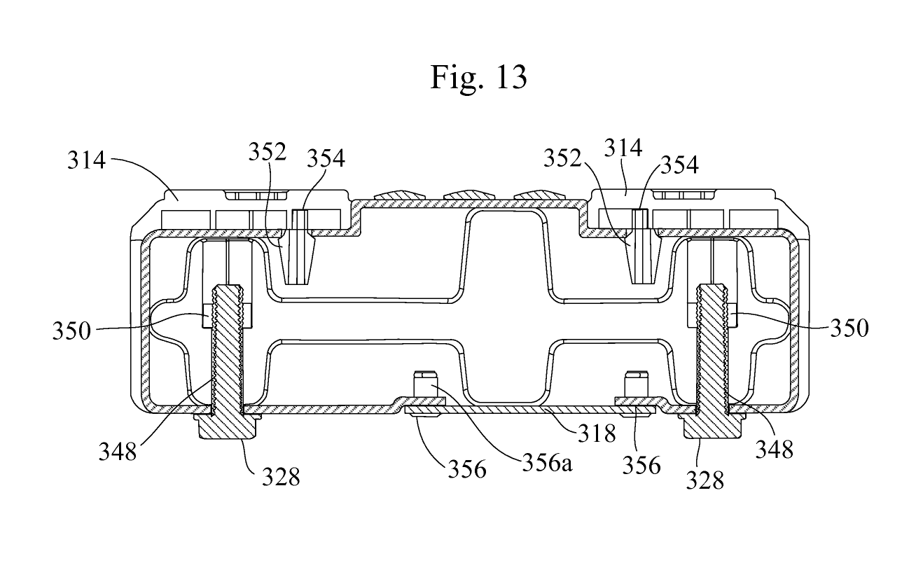

Referring briefly to FIG. 13, the ramp fitting 324 can be seen secured to the rectangular component 310 by threaded fasteners 328 which extend into holes 348 in the ramp fitting and engage with threaded nuts 350. Rubber or elastomer pads 314 may be secured to the rectangular component 310 by compressible fastener portions 352 which are press fit into holes 354 in an upper surface of the rectangular component 310. Panel 318 is secured via RIVNUT® fasteners 356 and corresponding threaded screws 356a.

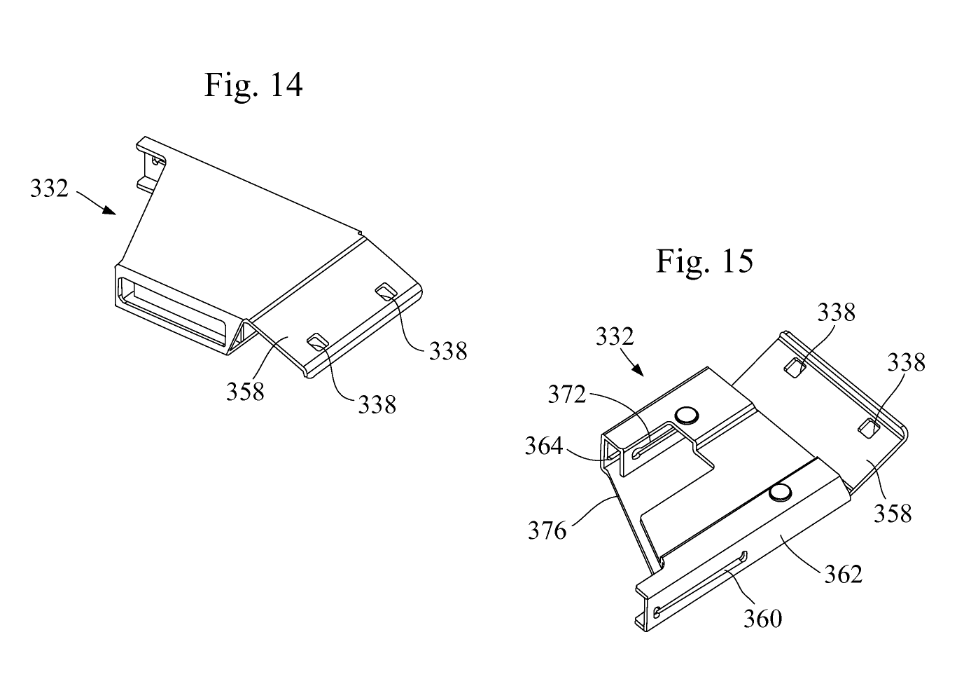

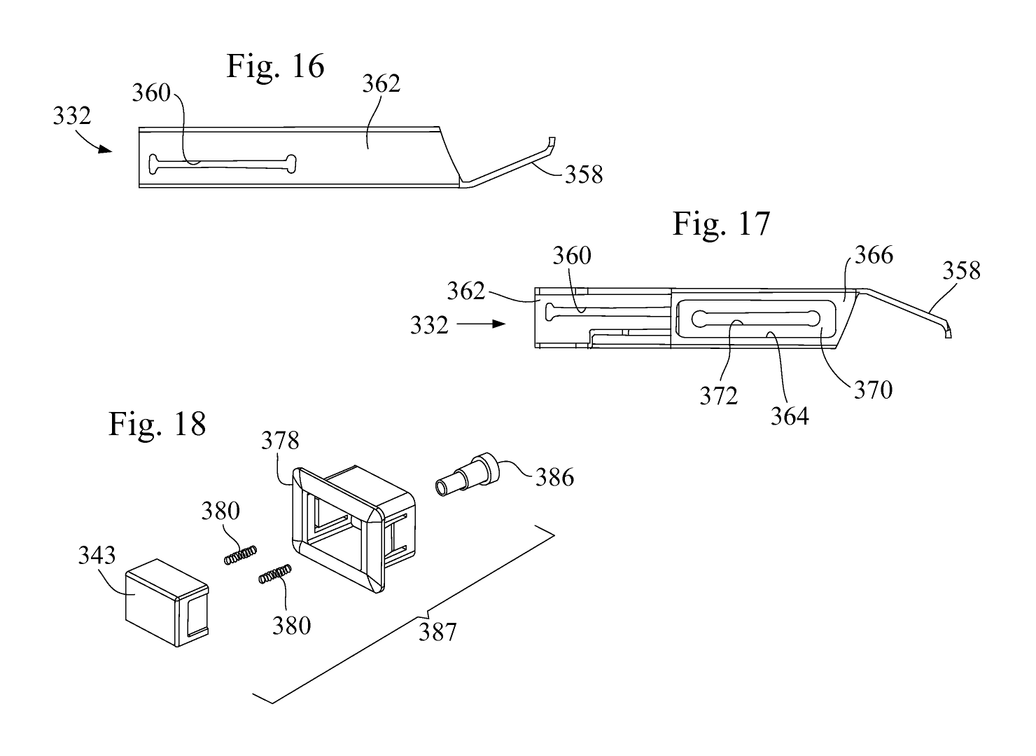

Referring to FIGS. 14-17, the grapple 332 is shown in greater detail. The grapple 332 includes an angled end portion 358 having the openings 338. A first slot 360 is formed on a first sidewall 362 (FIGS. 15 and 16), and a second slot 364 is formed on a second wall 366 (FIG. 17). An inner wall portion 370 (FIG. 15) also includes a slot 372. Slot 364 is dimensioned to receive the grabble release button 343, which also extends through a similarly shaped opening 374 (FIG. 12) in the rectangular element 310.

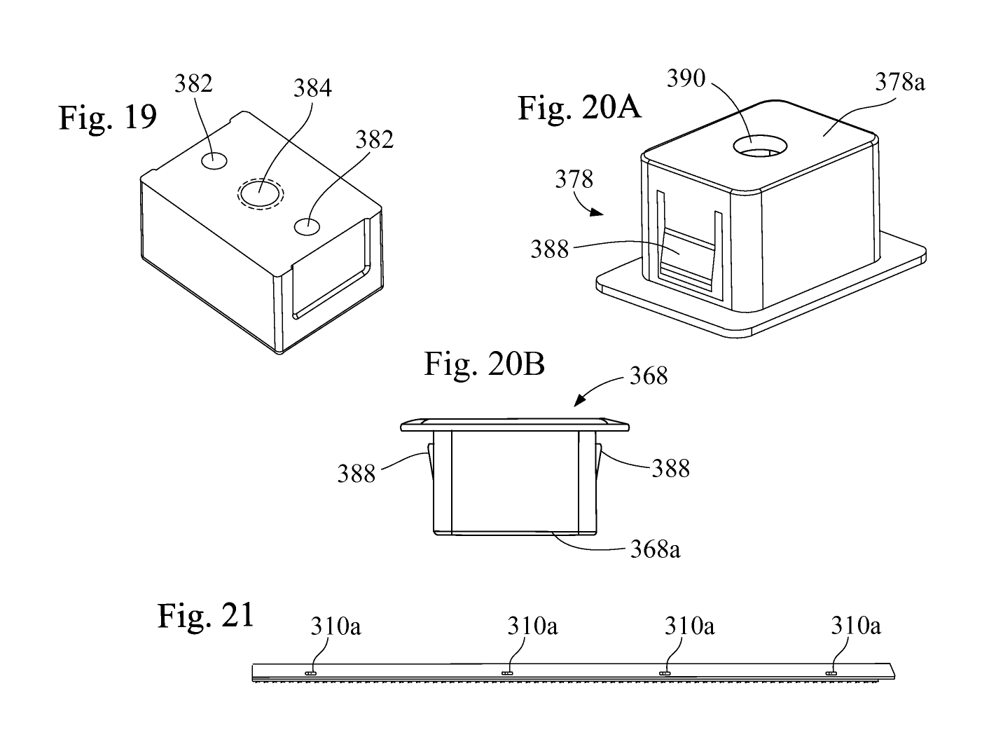

With reference to FIGS. 18 and 19, the grapple release button 343 is positioned within a housing 378 and biased outwardly by a pair of springs 380 (FIG. 18). In FIG. 19, the grapple release button 343 can be seen to include a pair of bores 382 which receive portions of the springs 380, and a blind center tapped bore 384 which receives a threaded shoulder bolt 386 that rides within the slot 364.

FIGS. 20A and 20B show the housing 378 having a pair of flexible arms 388 and a center opening 390. The threaded shoulder bolt 386 is positioned through the center opening 390 before being threadably secured to the grapple release button 343. With brief reference to FIG. 18, a head portion 386a of the shoulder bolt 386 engages within the slot 364 when the grapple release button 343 is assembled into the housing 378. The springs 380 serve to bias the grapple release button 343 outwardly and hold the head portion 386a of the shoulder bolt retracted against a backside 378a of the housing 378. The flexible arm portions 388 enable the housing 378 to be push fit into the opening 374 (FIG. 12) in the rectangular element 310 and retained therein after assembling the shoulder bolt 386 and grapple release button 343 thereto. Together, the release button 343, springs 380, housing 378 and shoulder bolt 386 form the grapple release assembly 387.

When the grapple release button 343 is not being depressed, the head portion 386a of the shoulder bolt 386 rests within the slot 364 and prevents the grapple 332 from being extended out from the rectangular element 10. When the user pushes the grapple release button 343 in, this causes the head portion 386a to be moved inwardly towards a longitudinal centerline of the rectangular element 10 and out the slot 364. While the button grapple release 343 is held in this position, the entire grapple 332 may be slid telescopically out from the rectangular element 310 a short distance defined by the longitudinal length of slot 364. Slot 360 engages the hook portion 304a of an outermost one of the support elements 304 to prevent the inward longitudinal side of the step assembly 302 from being lifted off of the support elements. Similarly, the hook portions 304a of the other support elements 304 engage slots 310a along a rear surface of the rectangular support element 310, as shown in FIG. 21, which prevents the entire rear edge of the step assembly 302 from being lifted off the support elements 304.

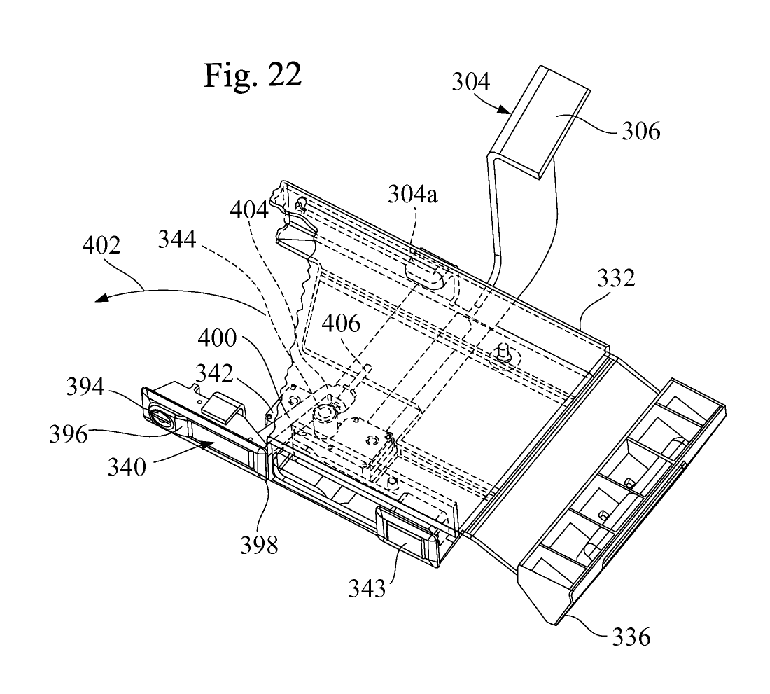

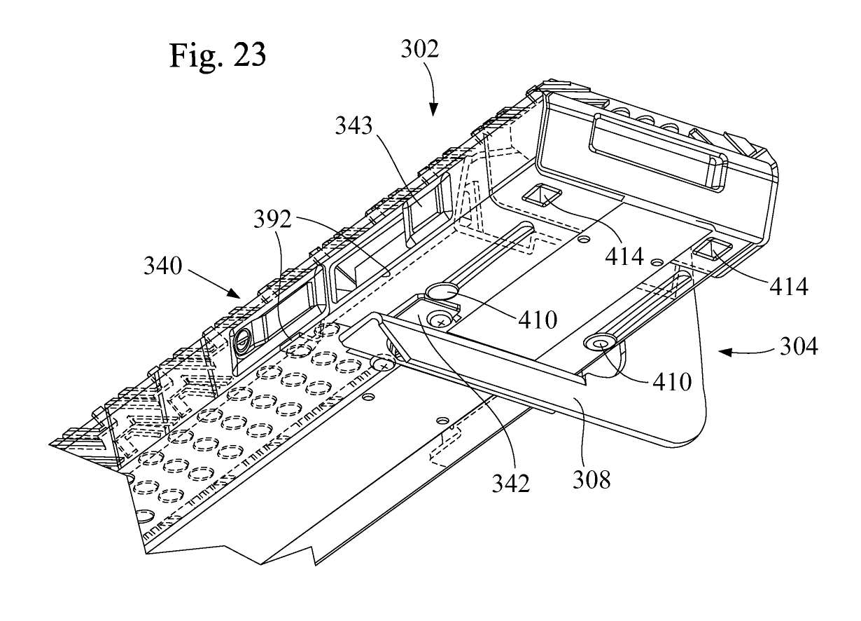

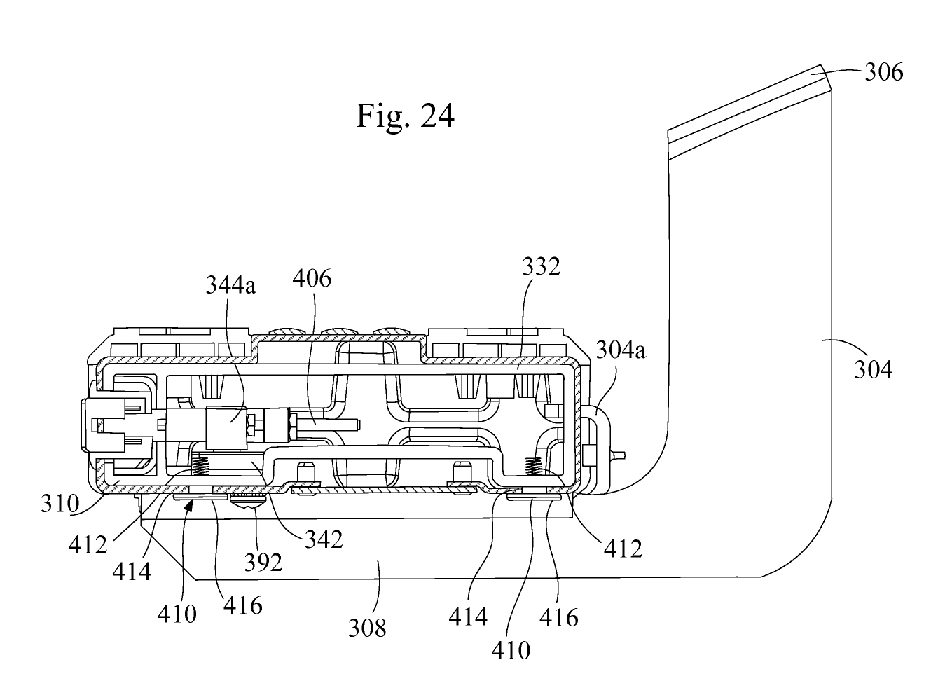

Referring to FIGS. 22-24, one of the latching assemblies 340 can be seen engaged with one of the strikers 344 (FIGS. 22 and 24). The latch plate 342 is secured via a plurality of threaded fasteners 392 to a lower surface of the rectangular element 310 (FIG. 23). As can be seen in FIG. 22, the latching assembly 340 includes a lock 394 which can be unlocked with a key (not shown). When unlocked, a latch body 396 may be pivoted outwardly about pivot pin 398. This causes an arm portion 400 to rotate in accordance with arrow 402 out from engagement with the striker 344. The arm portion 400 may include an elbow 404 with a threaded adjustment screw 406 that enables precise adjustment of the engagement with the striker 344 when the arm portion is moved back into its locked position as shown in FIG. 22. The latch body 396 can thus be moved easily by the user with just one or two fingers between the latched and unlatched positions.

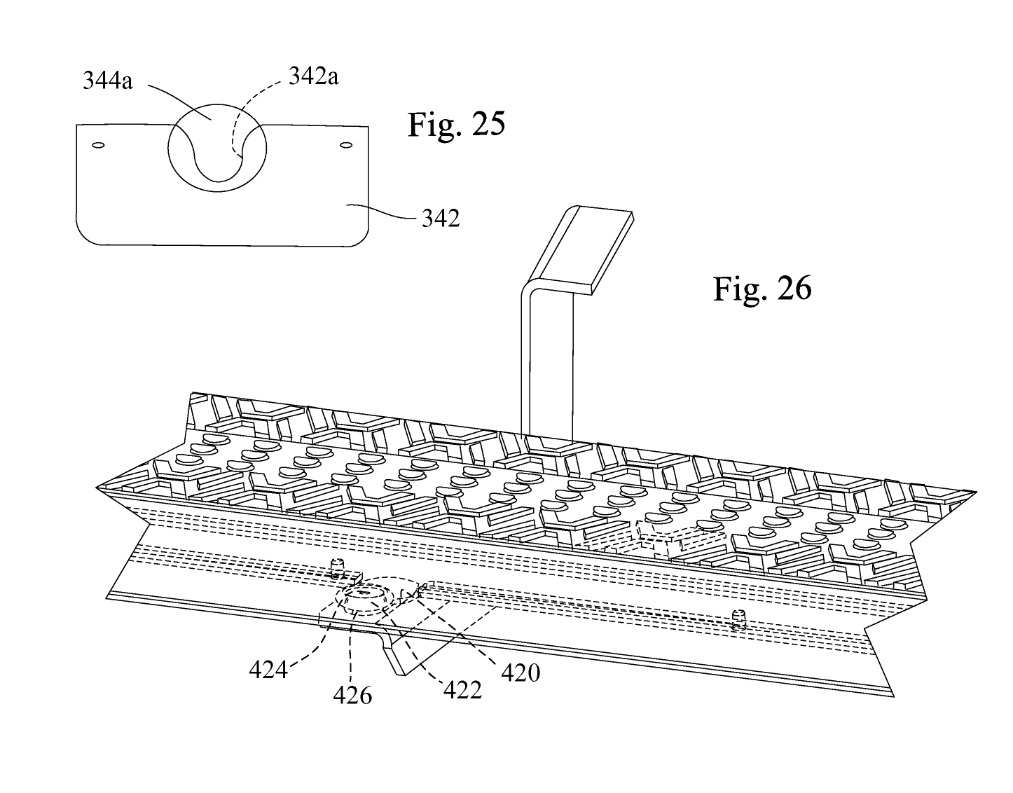

As shown in FIG. 24, when the latch body 396 is in the latched position, the arm portion 400 will be engaged with the striker 344. This prevents the step assembly 302 from simply being pulled outwardly along the support elements 304 away from the vehicle. It will also be noted in FIG. 25 that when the latch plate 342 is engaged with the striker 344, a head portion 344a of the striker 344 is larger in diameter than an key-like opening 342a in the latch plate 342. This prevents the step assembly 302 from simply being lifted upwardly off of the support element 304 when the latch body 396 is in the latched position relative to the striker 344. Thus, to remove the step assembly 302, the latch assemblies 340 both need to be moved into their unlatched positions, and then the opposite ends of the step assembly 302 may be slid away from the vehicle a short distance so that the hook portions 304a are clear of the step assembly and the strikers 344 are completely clear of the key-like openings 342a in the strikers 342. At that point the step assembly 302 may be lifted off of the support elements 304.

With brief reference to FIGS. 23 and 24, to further assist in enabling smooth sliding movement of the grapple 332, threaded fasteners 410 extend into threaded engagement with threaded holes 412 in a lower surface of the grapple 332, and through slots 414 in a lower surface of the rectangular element 310. Enlarged head portions 416 of each threaded fastener 410 thus help to prevent the grapple 332 from being completely detached from the rectangular member 310, while still permitting sliding movement of the grapple 332 between its extended and retracted positions.

With reference to FIG. 26, to further ensure that the ramp assemblies 302 do not vibrate or rattle when secured to the support elements 304, the rectangular element 310 may include enlarged, key-like openings 420 which are aligned with the longitudinal positions of the two centermost support elements 304. Each key-like opening 420 may be dimensioned to receive a rubber or elastomer ring-like element 422 which is secured to the second portion 308 of each of the centermost pair of support elements 304 via conventional threaded fasteners 424. A standoff or spacer 426 associated with each fastener 424 provides a small thickness just slightly greater than the cross sectional thickness of a lower surface of the rectangular element 310. Thus, to secure the step assembly 302 to the support elements 304, the step assembly may be positioned on the support elements so that the ring-like element 422 is received within the key-like opening 420. The step assembly 302 may then be pushed inwardly slightly toward the vehicle, wherein the ring-like element 422 will be captured in the smaller section of the key-like opening 420. The ring-like element 422 at each support element 304 has a small degree of compressibility which helps to wedge or clamp the step assembly 302 down onto the two centermost ones of the support elements 304.

The various embodiments of the present disclosure all enable a pair of step rails to be incorporated which are removable and useable as cargo loading ramps to assist in loading cargo into or out from a cargo area of a vehicle. The ramps and the step rail system of the present disclosure do not add appreciable weight because they are used in place of traditional, fixed mounted step rails. The step assemblies can be quickly and easily removed for use without any tools and without complicated release procedures. Since the step assemblies are used as step platforms when they are being stowed, they do not consume any storage space in the bed of a pickup truck, which would be the case if the step assemblies were dedicated ramps. The various embodiments are all light in weight and may be handled easily by most individuals. When the need arises to remove the step assemblies from their positions as step platforms and use them as ramps, then they may be easily removed by a single individual and re-positioned on the tailgate of the vehicle as ramps for use in loading and unloading cargo from the bed of the pickup truck.

It will also be appreciated that while the various embodiments have been described in connection with a fixedly support arrangement relative to the vehicle's frame, that the various embodiments could just as readily be incorporated with support rails that retract and extend from underneath the vehicle, as with many present day step rail systems used on pickup trucks. Such step rails typically extend when the vehicle's “unlock” door lock button on a key FOB is pressed, and typically retract when the door is locked. All of the embodiments discussed herein could be configured as automatically extending/retracting step rails.

It will also be appreciated that the various embodiments may be adapted for use with little or no modifications on vehicles besides pickup trucks, for example medium and large SUVs, vans, crossovers, etc., which would benefit from having a step rail that may also be used as a cargo loading/unloading ramp. With SUVs, however, which typically incorporate a liftgate instead of a tailgate, the ramps would need to be supported from the floor of the cargo area or structure adjacent the rear bumper.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A step rail system readily configurable for use as either a step platform along a side of a motor vehicle, or also as a loading ramp for use in loading cargo into a cargo bed of the motor vehicle, the step rail system including:
a step assembly forming a tubular assembly;
a plurality of support elements each having a first end which is affixed to a portion of the vehicle, and a second end on which the step assembly may be supported;
a striker fixedly secured to one of the support elements;
a user engageable latching assembly carried on the step assembly for releasably engaging the striker when the step assembly is positioned on the support elements, to thus secure the step assembly to the support elements in a first configuration for use as the step platform; and
the user engageable latching assembly enabling the step assembly to be detached from the support elements and used as a loading ramp to facilitate movement of cargo to and from the cargo area of the vehicle.

2. The system of claim 1, further comprising a grapple coupled to one end of the tubular assembly, the grapple able to be telescopically extended out from a retracted position in the one end to an extended position, to engage an edge surface of the cargo bed when the step assembly is being used as a ramp.

3. The system of claim 2, further comprising a manually engageable grapple release assembly for locking the grapple in its retracted position.

4. The system of claim 3, wherein the grapple release assembly includes a spring biased grapple release button configured to be engaged with a finger of a user, and released through an action of the user depressing the grapple release button.

5. The system of claim 1, wherein the latching assembly includes:
a pivotally mounted latch body having a lock, the latch body being moveable by a finger of a user between a latched position and an unlatched position;
an arm portion extending from the latch body; and
wherein the arm portion engages the striker when the latching assembly is urged into its latched position.

6. The system of claim 5, wherein the latching assembly further includes an elbow extending from the arm portion, and a threaded element extending through the elbow portion, the threaded element enabling a degree of adjustment of the engagement of the arm portion with the striker.

7. The system of claim 6, further comprising a latch plate having an opening which receives the striker when the step assembly is in position to be latched to the support element.

8. The system of claim 1, wherein at least one of the support elements includes a ring like element secured to the second portion, the ring-like element being at least slightly compressible and operating to engage with a key-like opening in a lower surface of the rectangular element of the step assembly, to thus help reduce or eliminate vibration and rattling of the step assembly while the step assembly is latched to the support elements.

9. The system of claim 1, wherein at least one of the support elements includes a hook portion, and wherein the rectangular element of the step assembly includes a slot for engaging with the hook portion when the step assembly is positioned on the at least one support element for use as the step platform.

10. The system of claim 1, wherein the step assembly includes a stippled metal section on an upper surface of the rectangular element.

11. A step rail system readily configurable for use as either a step platform along a side of a motor vehicle, or also as a loading ramp for use in loading cargo into a cargo bed of the motor vehicle, the step rail system including:
a step assembly forming a tubular assembly having a rectangular element;
a plurality of support elements each having a first end which is affixed to a portion of the vehicle, and a second end on which the step assembly may be supported;
a striker fixedly secured to each one of a pair of the support elements;
a user engageable latching assembly carried on the step assembly for releasably engaging the striker when the step assembly is positioned on the support elements, to thus secure the step assembly to the support elements in a first configuration for use as the step platform, the latching assembly including a pivotally movable latch body having a lock enabling the step assembly to be locked to the support elements; and
the user engageable latching assembly enabling the step assembly to be detached from the support elements and used as a loading ramp to facilitate movement of cargo to and from the cargo area of the vehicle.

12. The system of claim 11, further comprising a telescopically extendable grapple secured to one end of the step assembly to be telescopically extended and retracted from the rectangular element without being detachable therefrom, the grapple being configured to engage an edge surface of the cargo bed when the step assembly is being used as a ramp.

13. The system of claim 11, wherein the latch body includes an arm portion for engaging with the striker when the latch body is in its latched position and the step assembly is positioned on the support elements.

14. The system of claim 13, wherein the arm portion includes an elbow having a threaded element extending through the elbow for enabling a degree of adjustment of the engagement of the arm portion with the striker.

15. The system of claim 11, wherein the latch body is positioned within a cutout in a wall portion of the rectangular element.

16. The system of claim 12, further comprising a grapple release assembly for enabling a user to manually release the grapple to allow the grapple to be extended from the rectangular element.

17. The system of claim 16, wherein the grapple release assembly includes a spring biased grapple release button disposed in a cutout in a wall portion of the rectangular element of the step assembly.

18. The system of claim 11, wherein the step assembly includes a ramp fitting for closing off one end of the rectangular element.

19. A step rail system readily configurable for use as either a step platform along a side of a motor vehicle, or also as a loading ramp for use in loading cargo into a cargo bed of the motor vehicle, the step rail system including:
a step assembly forming a tubular assembly having a rectangular element;
a plurality of support elements each having a first end which is affixed to a portion of the vehicle, and a second end on which the step assembly may be supported;
a striker fixedly secured to each one of a pair of the support elements;
a user engageable latching assembly carried on the step assembly for releasably engaging the striker when the step assembly is positioned on the support elements, to thus secure the step assembly to the support elements in a first configuration for use as the step platform, the latching assembly including a pivotally moveable latch body having a lock enabling the step assembly to be locked to the support elements;
a telescopically extendable grapple secured to one end of the step assembly to be telescopically extended and retracted from the rectangular element without being detachable therefrom, the grapple being configured to engage an edge surface of the cargo bed when the step assembly is being used as a ramp;
a manually engageable grapple release assembly for enabling a user to release the grapple and move the grapple to an extended position from a retracted position using a finger of one hand, and for further enabling the grapple to be secured in a retracted position; and
the user engageable latching assembly enabling the step assembly to be detached from the support elements and used as a loading ramp to facilitate movement of cargo to and from the cargo area of the vehicle.

20. The system of claim 19, wherein the latch body includes an arm portion and an elbow, the elbow having a threadable element assembly for enabling adjustment of the latch arm position relative to the striker.
